(19) United States
(12) Patent Application Publication
(10) Pub. No.: US 2009/0187572 A1
(43) Pub. Date: Jul. 23, 2009

(54) Systems and methods for providing access to instructional content

(76) Inventors: Edward M. Ives, Exeter, RI (US); David J. Smith, Viera, FL (US)

Correspondence Address: WOLF GREENFIELD & SACKS, P.C., 600 ATLANTIC AVENUE, BOSTON, MA, 02210-2206, US

(21) Appl. No.: 12/009,362

(22) Filed: Jan. 18, 2008

(51) Int. Cl. G06F 17/30

(52) U.S. Cl. 707/10; 707/E17.001

(57) ABSTRACT

Methods and apparatus are provided for locating trustworthy how-to content (e.g., on the Internet), and providing access to such content (e.g., via a web site). Some embodiments provide a method for making trustworthy how-to content accessible, which method includes locating an item of how-to content made available for access by a provider; creating at least one how-to entry corresponding to the item of how-to content which enables a user to access the how-to content and which includes some indication of the source (and thus also, to a user familiar with the source, an indication of the quality) of the how-to content; and providing the user with access to the how-to entry via at least one network (e.g., the Internet).

### FIELD OF THE INVENTION

This invention relates generally to systems and methods for providing users with access to instructional content for accomplishing various tasks.

### BACKGROUND OF INVENTION

On-line instructions for, or information providing guidance on, performing one or more tasks (referred to herein for convenience as “how-to content” or “a how-to”) are conventionally available in a variety of formats, including text (e.g., written instructions in Hypertext Markup Language (HTML), Portable Document Format (PDF), Microsoft Powerpoint presentation, etc.), video, audio, graphical (e.g., displayed on a web site using Adobe's Flash), combinations thereof, and other formats. Many organizations, including businesses, educational institutions, government entities and individuals, create how-to content on a wide variety of topics and make it available for access via the Internet. How-to content may be written by topic experts, professional writers, amateurs, online collaborative communities, or other authors. Statistics on Internet search activity indicate that a significant percentage of all searches performed by users in the United States begin with the phrase “how to,” indicating significant user demand for access to how-to content.

Conventionally, users locate how-to information on the Internet using one of three main approaches. That is, users typically look for how-to content by performing an Internet search (e.g., using a general-purpose search engine such as Google), by examining a website that provides specialized information on a particular topic or theme (e.g., a website which provides how-to content relating to particular types of tasks, such as a site operated by The Home Depot company providing how-to content on home improvement tasks), or by accessing a specialized website dedicated to making how-to content on a wide variety of tasks available to users.

### SUMMARY OF INVENTION

Applicant has appreciated that conventional approaches for locating how-to content present unnecessary difficulties for the user. Accordingly, some embodiments of the invention provide systems and methods for locating how-to content and making how-to content available to the user in an intuitive and user-friendly manner.

For example, Applicant has appreciated that a general-purpose search engine, while offering the user access to a wide variety of how-to content resources, typically will return numerous results that the user may find irrelevant, unreliable, incorrect, or irrelevant to the task at hand. To identify the actually desired or relevant results from among all of the results may require a tedious manual process of examining each result in turn. Thus, a great deal of time may be expended in reviewing useless results. In general, this is because the algorithms used by general-purpose search engines are incapable of effectively evaluating the overall quality, and hence trustworthiness and reliability, of how-to content on web pages corresponding to search results. In general, these algorithms are designed to try to determine the quality or relevance of web pages corresponding to search results, such as by analyzing information found within a web page's content and/or other purportedly objective indications of the quality of information presented on a web page. For example, the Google search engine scores each web page based in part on the number of links to that page from other web pages, so that a page that is linked to frequently by other pages is scored more highly (and thus deemed of higher quality) by the Google search algorithm. However, since web pages can be computer-generated and easily copied from other sources, some web site operators employ techniques designed to dupe search engine algorithms and artificially inflate the scores their web pages receive. For example, some operators build “link farms” consisting of numerous pages at multiple domain names which link to each other, thereby causing these pages to score more highly in search engine results. As a result, Applicant has appreciated that general-purpose search engines can not be relied upon to distinguish high-quality, trustworthy results for a user's search for how-to content on the Internet.

Searching a web site that provides information on a specialized topic or theme also suffers from several disadvantages. Specifically, while such a web site may return search results that are smaller in number than a general-purpose search engine and specific to a particular content area, the user must at the outset determine that the web site offers trustworthy content, which may not be easy given the number of sites available, especially if the user is unfamiliar with providers of services relating to the topic being searched. Also, once a web site is chosen, if the site does not include how-to content for the topic searched, the search may be unsuccessful and user may become frustrated. Even if content is available, the user may decide that it is inadequate for any of numerous reasons. Further, the user's goals may not align with those of the operator of the site. For example, the operator may make content available which recommends something more beneficial for the operator than the user (e.g., that the user purchase a product offered by the operator to perform a particular task).

A specialized how-to content web site may offer content on a wide variety of tasks, but this type of site characteristically provides only one version of how-to content for each task, so if the how-to content provided for a given task is inadequate, the user must locate and access another how-to web site. In addition, although some specialized how-to web sites offer content written by professional writers, the user must still evaluate whether the content is trustworthy. Some how-to web sites offer content contributed by members of a community of anonymous or little-known contributors, which can make it even more difficult for the user to evaluate the trustworthiness and reliability of how-to content.

Accordingly, some embodiments of the invention locate trustworthy how-to content and make it available to users in a user-friendly and intuitive manner, so that users can easily find the how-to content they seek without having to sift through irrelevant or untrustworthy search results. For example, some embodiments provide a web site which aggregates how-to content from multiple trustworthy providers, and enables the user to select from multiple versions of how-to content for a given task (e.g., a version from each of several providers, so that the user can select a version that best meets their needs and/or view multiple perspectives on approaching a task). Each version may be provided in the form of a hyperlink which specifies the brand name of the associated provider (thereby enabling the user to evaluate the trustworthiness and reliability of the associated content), or some other indication of quality, and links to a page on the provider's web site at which the how-to content resides.

Some embodiments provide a computer-implemented method for providing access to trustworthy how-to content. The method comprises computer-implemented acts of: (A) locating how-to content made available for access via at least one network by an online provider; (B) creating in a data structure at least one how-to entry which corresponds to the how-to content, the how-to entry being selectable by a user to access the how-to content via at least one network, the how-to entry indicating that the how-to content is made available by the online provider; and (C) providing the user with access to the how-to entry via at least one network.

Other embodiments provide at least one computer-readable medium encoded with instructions which, when executed by a computer, perform a method for providing access to trustworthy how-to content. The method comprises acts of: (A) locating how-to content made available for access via at least one network by an online provider; (B) creating in a data structure at least one how-to entry which corresponds to the how-to content, the how-to entry being selectable by a user to access the how-to content via at least one network, the how-to entry indicating that the how-to content is made available by the online provider; and (C) providing the user with access to the how-to entry via at least one network.

Still other embodiments provide a system for making trustworthy how-to content available to users. The system comprises a location facility operable to receive an indication of a network location at which an item of how-to content is made available for access by an online provider; a database facility in networked communication with the location facility, the database facility being operable to store the indication of the network location received by the location facility; a creation facility in networked communication with the database facility, the creation facility being operable to access the indication stored in the database facility and to create, in a data structure, a how-to entry for the item of how-to content, the how-to entry being selectable by a user of the system to access the item of how-to content at the network location, the how-to entry indicating that the how-to content is made available by the online provider; and an access facility operable to make the how-to entry accessible to the user via at least one network.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram depicting an example system for making how-to content available via the Internet, in accordance with some embodiments of the invention;

FIG. 2 is a representation of an example graphical user interface (GUI) which enables an operator to categorize a web page including how-to content, in accordance with some embodiments of the invention;

FIG. 3 is a flowchart depicting an example process for making how-to content available to users, in accordance with some embodiments of the invention;

FIG. 4 is a representation of an example GUI for receiving user search terms and presenting how-to content categories to the user, in accordance with some embodiments of the invention;

FIG. 5 is a representation of an example GUI for presenting how-to content entries to the user, in accordance with some embodiments of the invention;

FIG. 6 is a representation of an example GUI presenting example how-to content, in accordance with some embodiments of the invention;

FIG. 7 is a representation of an example GUI presenting example how-to content, in accordance with some embodiments of the invention;

FIG. 8 is a block diagram conceptually depicting an example technique for organizing how-to content, in accordance with some embodiments of the invention;

FIG. 9 is a representation of an example GUI for presenting how-to content categories and topics, in accordance with some embodiments of the invention;

FIG. 10 is a representation of an example schema which may be employed to store information relating to how-to content, in accordance with some embodiments of the invention;

FIG. 11 is a block diagram depicting an example computer system on which some embodiments of the invention may be implemented; and

FIG. 12 is a block diagram depicting an example memory on which instructions embodying aspects of the present invention may be stored.

### DETAILED DESCRIPTION

Some embodiments of the present invention provide access to how-to content in a user-friendly and intuitive manner. For example, some embodiments provide a web site that organizes how-to content into easy-to-understand how-to categories. As such, users may browse or search the site for particular how-to content (e.g., guidance on approaching a particular undertaking) or categories of how-to content (e.g., to view how-to content on multiple topics). In some embodiments, categories of how-to content are organized hierarchically, with each how-to category including at least one how-to topic (e.g., relating to performing a particular task), and each how-to topic including one or more how-to entries (e.g., each corresponding to content made available by a different provider on approaching that task). For example, how-to content providing instructions on how to fix a squeaky floor may be classified as belonging to a “Home and Garden” category and “Floors” sub-category. Within the “Floors” sub-category, there may be several how-to topics relating to, for example, the installation, care and maintenance of flooring. One how-to topic might relate specifically to fixing a squeaky floor, and this how-to topic may include one or more how-to entries. Each entry may, for example, include a hyperlink to content on a web page made available by a different provider (e.g., web site operator). As a result, the user may be given access to how-to information in a user-friendly, intuitive and structured manner, and may be allowed to select from among how-to content made available by multiple providers.

In some embodiments, each how-to entry indicates that corresponding how-to content is made available by an entity having a brand name of some stature, which may provide some indication, to users familiar with the brand name, of the trustworthiness of the underlying how-to content. As a result, rather than relying on a general-purpose web site's ability to discern trustworthiness from the content of the web page, or from the relationships between the web page and other web pages, the user may be presented with an indication of the trustworthiness and reliability of how-to content (i.e., in the form of the brand reputation of the source of the content). In some embodiments, a web site of how-to information is populated with how-to entries corresponding to content made available by only certain trusted providers, which may be determined using any suitable criteria. For example, trusted providers may be identified via survey results, independent rating services, and/or any other objective indication(s) of providers' standing and reputation in the marketplace. By limiting the universe of how-to entries which the user is presented with when attempting to locate how-to content, the web site may provide assurance that the underlying content will be relevant and of good quality. As a result, users may quickly and easily locate trusted, reliable how-to information.

It should be appreciated that a how-to entry need not employ a provider's brand name to denote the source and/or quality of corresponding how-to content, as any suitable indication of source and/or quality may be employed. For example, a how-to entry may indicate that corresponding how-to content is made available by a particular provider using a logo, word, phrase, symbol, design, image, other (e.g., non-visual) indication, or combination thereof, which is associated with the provider or any one or more products or services offered thereby. Any suitable indication(s) may be employed, as the invention is not limited in this respect.

In some embodiments, each entry for a particular how-to topic is given the same name, providing an indication that, although the underlying web pages may have different titles, each entry provides a different version of substantially the same underlying how-to content. For example, while two different web pages made available by different home improvement retailers may be titled “Stopping squeaks” and “Fixing a squeaky floor,” respectively, giving the how-to entries which reference these pages the same title (e.g., “How to fix a squeaky floor”) simplifies the visual display presented to the user, enabling him or her to quickly ascertain that the underlying content describes approaches to roughly the same task, further easing the user's burden in selecting how-to content.

Some embodiments of the invention provide systems and methods for locating trustworthy how-to content, creating how-to entries referencing such content, and organizing such how-to entries into navigable and/or searchable categories, thereby enabling users to locate how-to content quickly and easily. For example, some embodiments provide a computer-implemented (e.g., automated or semi-automated) process for locating how-to content on web sites and cataloguing the Uniform Resource Locator (URL) associated with each web page in electronic file storage (e.g., a database). In some embodiments, a logical relationship may be created between each URL and a how-to entry, topic and/or one or more categories, and an indication of this relationship may be stored in the electronic file storage. As a result, each how-to entry may specify a brand name, providing an indication of the reliability of the content on the page referenced by the URL. Some embodiments may provide a search facility that allows the user to search for how-to content (e.g., on the site). A search facility may, for example, be configured to receive user input in the form of one or more search terms, in a manner which is familiar to most users of the Internet. A user's search request may be processed to generate results, such as how-to entries, topics and/or categories, allowing the user to quickly locate how-to content on a wide variety of topics.

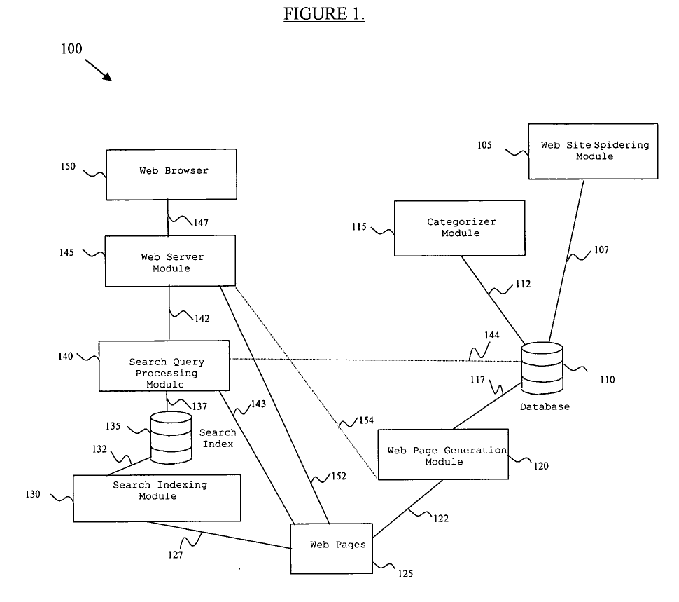

FIG. 1 depicts an example system 100 for locating, categorizing and providing access to how-to content. Specifically, system 100 includes components which enable an operator to locate, assess and categorize how-to content, and make that content available to a user (e.g., via the Internet). A user of system 100 may navigate or search for specific how-to content, or examine categories of content and/or review certain topics to find the specific how-to content they seek.

System 100 includes web site spidering module 105, which in some embodiments may comprise one or more software components configured for execution on a computer (not shown) connected to the Internet or other public or private network. Specifically, web site spidering module 100 may be programmed to retrieve systematically a collection of URLs, such as from one or more web sites indicated (e.g., by a human or software-based editor) as including how-to content, or any other publicly available or private collection of content. If configured to examine publicly available web sites, web site spidering module 100 may include features commonly available on spidering software, such as features which instruct web site spidering module 100 to examine only certain page levels of the web site(s), to filter URLs based on text strings found therein and/or in the title of corresponding pages, and/or to filter URLs based on text found in the content of associated pages.

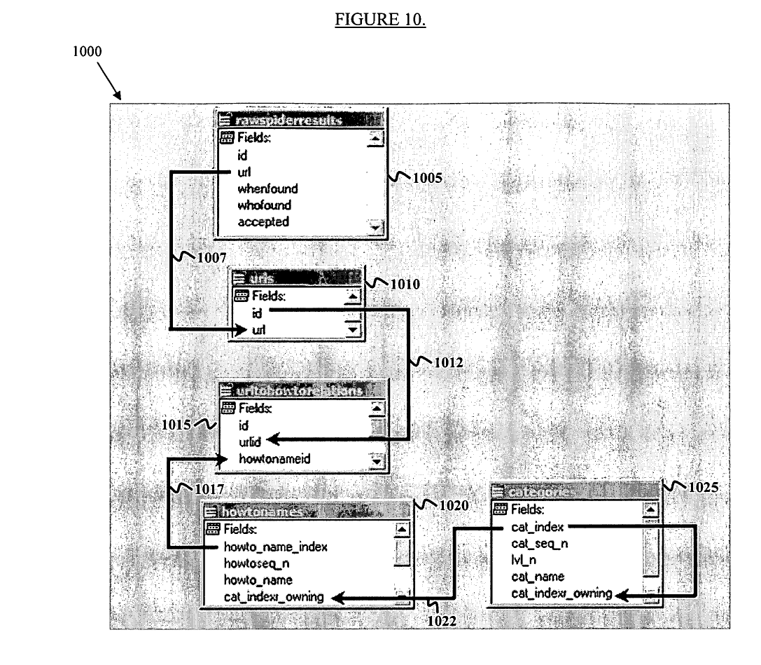

In the example system 100 shown, the URLs located by web site spidering module 105 are loaded to database 110. Web site spidering module 105 communicates with database 110 via link 107, which, like every other link shown in FIG. 1, may comprise any one or more communications networks, such as a LAN, WAN, wireless network, the Internet, other network, or a combination thereof. Database 110 may, in some embodiments, comprise any suitable database management system application and any suitable amount and type of storage media, as the invention is not limited to any particular implementation. Database 110 may store, in any suitable fashion (e.g., in a relational or other database structure), information relating to how-to content, such as URLs located by web site spidering module 105, how-to entries, topics and categories, and information required for operation of system 100. An example schema which may be implemented by database 110 to store information is described below with reference to FIG. 10.

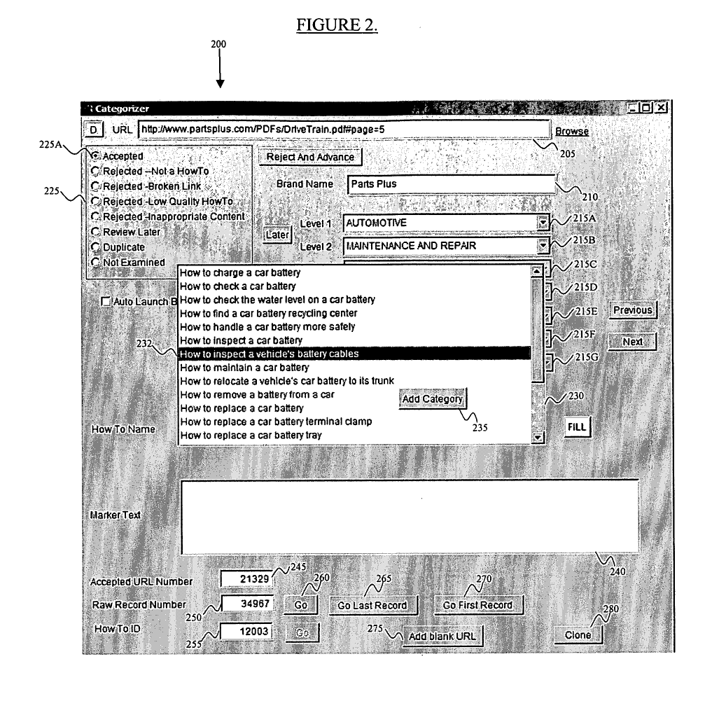

In the example system 100 shown, categorizer module 115 is employed by an editor to assess the quality of content on pages referenced by URLs stored in database 110, create how-to entries for URLs deemed to be of sufficient quality, and categorize how-to content. Categorizer module 115 communicates with database 110 via link 112, and in some embodiments, provides a graphical user interface (GUI) (an example of which is described below with reference to FIG. 2) which accesses data stored in database 110 and enables an editor to create how-to entries and assign those entries to one or more categories. For example, a GUI presented by categorizer module 115 may enable an editor to inspect URLs located by web site spidering module 105, inspect and assess a web page associated with each URL to determine whether its content is of sufficient quality, create a how-to entry corresponding to URLs which the editor deems are of sufficient quality, and categorize the how-to entry in one or more categories. In some embodiments, each how-to entry includes a provider's brand name, so as to provide users of system 100 with an indication which the user may perceive to denote the entry's trustworthiness.

In some embodiments, the GUI presented by categorizer module 115 may also enable an editor to provide input defining URLs to be stored in database 110. For example, the GUI may be configured to receive editor input via a keyboard, or may allow an editor to specify a file containing URLs for loading to database 110. Thus, it should be apparent that URLs stored in database 110 need not be located by web site spidering module 105, and may be located and/or loaded to database 110 using any suitable technique (including techniques which do not involve the use of categorizer 115), as the invention is not limited in this respect.

In some embodiments, categorizer module 115 may comprise one or more software modules configured for execution on one or more computers (not shown in FIG. 1), although the invention is not limited to being implemented in this fashion. Any suitable combination of hardware and/or software may be used to implement categorizer module 115.

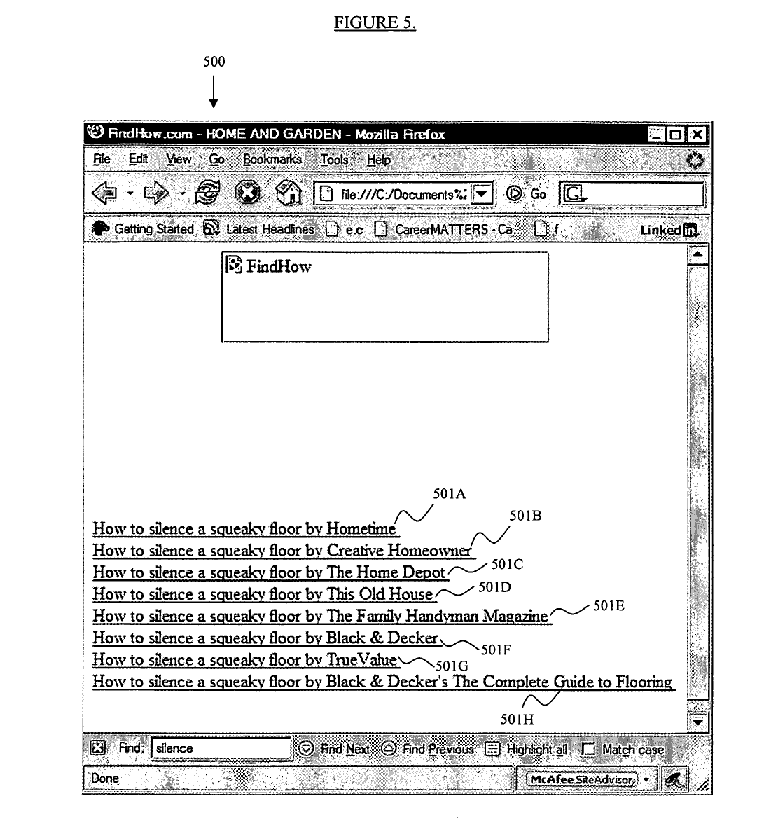

Web page generation module 400 accesses database 110 via link 117 and generates web pages 125, such as web pages which include how-to entries, topics and categories. In some embodiments, web pages 125 may comprise information provided in markup language (e.g., HTML, XML, etc.) format, although the invention is not limited to such an implementation. Some example web pages 125 generated by web page generation module 120 are described below with reference to FIGS. 5-7. It should be appreciated, however, that any suitable manner of presenting how-to content may be employed, and that the invention is not limited to the particular example embodiments disclosed herein. Further, it should be appreciated that web page generation module 400 may be implemented using any suitable combination of hardware and/or software components, as the invention is not limited to being implemented in any particular manner.

Search indexing module 600 accesses web pages 125 and constructs search index 135, which may provide a reference to any one or more properties of web pages 125 for use in later searching. For example, search index 135 may index web pages 125 according to their content (e.g., text contained therein), so that subsequent searches for particular keywords contained within the web pages (e.g., including how-to entries, topics, categories, etc.) may be processed efficiently.

Web browser 150 provides the user with access to web pages 125, and thus to how-to entries, topics and categories. Web browser 150 may include any one or more browser programs, configured for operation on any suitable computing device (e.g., personal computer, personal digital assistant (PDA), cellular telephone, wireless device, any other device, or a combination thereof). In some embodiments, web browser 150 enables the user to navigate to and view web pages 125 (e.g., to examine how-to content categories, topics, and entries) by issuing a retrieval request to web server module 145, which communicates with web pages 125 via link 152. Web browser 150 may also enable the user to perform a search for how-to content by communicating the parameters of a search request (e.g., one or more keywords) via link 147 to web server module 145, which then communicates the request via link 142 to search query processing module 140. Search query processing module 140 may then query search index 135 via link 137 in processing the search request, and utilize the results of the query in accessing web pages 125 via link 143. The results of the search may then be communicated to web browser 150 via web server module 145.

It should be appreciated that example system 100 represents only one possible architecture of a system configured for locating, categorizing and making available how-to content, and that numerous variations on example system 100 are possible. For example, web page generation module 120 need not generate web pages 125 prior to access by web server module web server module 145 or search query processing module 140. For example, search query processing module 140 may instead communicate directly with database 110 (or some other component(s)) to perform search queries. Similarly, web server module 145 may communicate directly with database 110, or with web page generation module 120, which may generate web pages dynamically in response to user input. In addition, web browser 150 may provide access to functionality provided by categorizer module 115 (e.g., via a web interface), such that categorizer module 115 need not be a stand-alone component. Numerous variations on example system 100 may be envisioned, and Applicant intends these variations to be within the scope of the invention.

FIG. 2 depicts an example interface window 200 which may be presented by categorizer module 115 and which may enable an editor to process URLs stored in database 110 (e.g., retrieved by web site spidering module 105). For example, interface window 200 may accept editor input to process URLs corresponding to how-to content (e.g., gathered by web site spidering module 105 and stored in database 110), create and name how-to entries corresponding to each URL, and categorize each how-to entry.

In the example shown, interface window 200 is presented by a software application configured for execution under a Microsoft Windows-family operating system, but the invention is not limited to such an implementation, as functionality associated with processing URLs and creating and categorizing how-to entries may be provided by any one or more components implemented via hardware and/or software. If implemented via software, components may be configured to execute on any one or more devices and/or under any suitable one or more operating systems.

Interface window 200 includes URL box 205, in which a URL corresponding to how-to content on a web site is displayed. The URL displayed in box 205 may be retrieved by web site spidering module 105, may be entered by the editor (e.g., using a mouse or keyboard), or provided in any other suitable fashion. Review input buttons 225 includes a collection of radio buttons which enable an editor to specify a disposition for the URL specified in box 205. Specifically, the radio buttons enable an editor to specify that the URL is accepted (e.g., signifying that the how-to content provided by a web page referenced by the URL is of sufficient quality), rejected (e.g., because the URL does not correspond to how-to content, is a broken link (i.e., does not reference any web page), corresponds to low-quality how-to content, or corresponds to inappropriate content), should be reviewed later, is (although identified by a unique URL) in fact a duplicate of content already recorded (e.g., stored in database 110), or is not yet examined. In the example shown, an editor has indicated via radio button 225A that the URL shown in box 205 is accepted and should be categorized.

Box 210 enables the editor to specify a brand name for the how-to corresponding to the URL. As noted above, a brand name may be employed to ascribe trustworthiness to the how-to corresponding to the URL.

Dropdown boxes 215A-215G enable the editor to assign a how-to entry corresponding to the URL to one or more categories. In the example shown, a hierarchical categorization scheme is employed, such that each of dropdown boxes 215A-215G specifies a category at a successively greater level of granularity. For example, an editor may specify a top-level category via dropdown box 215A of “automotive”, a second-level category level via dropdown box 215B of “maintenance and repair,” and so on. Data defining category names may, for example, be stored in database 110.

Dropdown box 230 allows the editor to select a name from among a list of predefined names for a how-to entry corresponding to the URL shown in box 205. In the example shown, the editor has selected entry 232, “How to Inspect a Vehicle's Battery Cables.” Of course, dropdown list 230 may include any suitable number of names, as the invention is not limited in this respect. Button 235 enables an editor to add a new name to the list shown by dropdown box 230, such that by clicking (or providing other input via) box 235, an editor may be prompted to supply input defining an additional how-to entry name.

It should be appreciated that by providing a list of predefined names for how-to entries, the system promotes the use of a single name for all how-to entries for a particular topic. By giving each entry in a how-to topic the same name, the visual display presented to the user may be simplified, enabling the user to quickly ascertain that underlying content describes approaches to the same task and eases the user's burden in selecting how-to content.

Other input facilities provided by interface window 200 allow an editor to manage other aspects of the URL intake process. For example, box 245 provides an indication of the quantity of URLs accepted (e.g. as indicated via radio button 225). Box 250 provides an indication of a record number (e.g., corresponding to a URL record), and buttons 260, 265 and 270 enable the editor to go to the record number specified in box 250, go to a “last” record, and go to a “first” record, respectively. Box 255 indicates the total number of how-to entries categorized in the system. Button 275 allows an editor to add a blank URL. Button 280 allows the editor to clone a particular URL.

In some embodiments, separate instances of interface window 200 may be employed by each of several editors, allowing a team to process a collection of URLs and create and organize associated how-to entries and other how-to content. For example, in some embodiments, interface window 200 may be presented by a software application which coordinates the simultaneous editing efforts of multiple editors, such as by locking URLs with associated editing in progress and preventing editors from accidentally corrupting each other's work.

It should be appreciated that the editors who review and categorize how-to content may include, for example, users of system 100 (FIG. 1). For example, a community of users may be given access rights to submit and/or categorize how-to content for presentation on one or more web pages 125 to, for example, other users of system 100. Members of the community may submit and/or organize how-to content using interface window 200, or any other suitable interface, as the invention is not limited to any particular implementation.

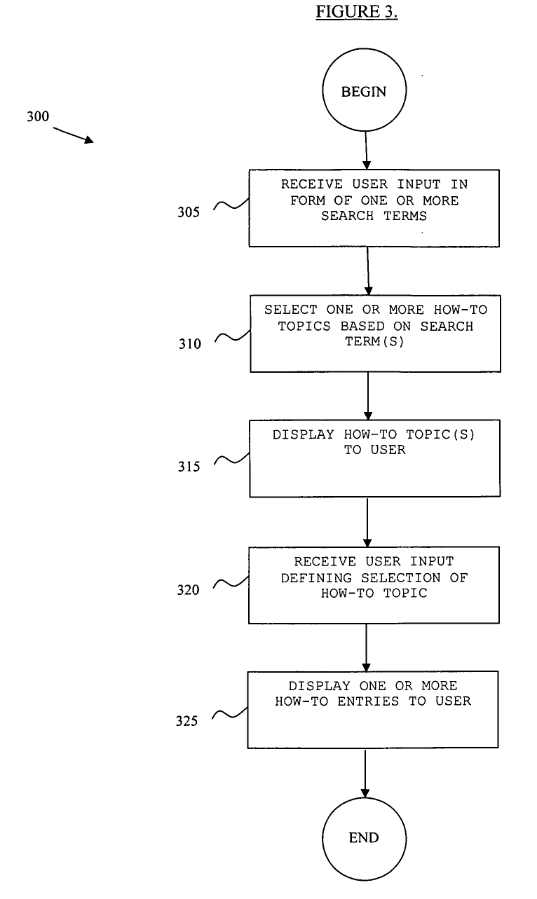

As described above, system 100 (FIG. 1) may provide users with access to how-to content, including how-to entries, topics and categories. An example process for providing a user with access to how-to content is shown in FIG. 3. In particular, FIG. 3 depicts a process 300 for processing a user's request to search for particular how-to content.

At the start of process 300, in act 305, user input in the form of a query specifying one or more search terms is received. For example, user input may be provided by the user via web browser 150 (FIG. 1) and received by web server module 145 via link 147, and provided via link 142 to search query processing module 140. It should be appreciated that while the example shown involves a search based on one or more terms or keywords, a search may be performed using any suitable input, which may not include any keywords or search terms. The invention is not limited to any particular implementation.

Process 300 then proceeds to act 310, wherein one or more how-to content topics are selected based on the search term(s) provided by the user. For example, search query processing module 140 may generate and execute a query on search index 135 and/or web pages 125. Of course, a search for how-to topics may be performed in any suitable fashion, as the invention is not limited in-this respect.

Process 300 then proceeds to act 315, wherein the how-to topics selected in act 310 are displayed to the user. This may be performed using any suitable technique. For example, web server module 145 may receive the results of the search performed by search query processing module 140 and provide the results, which may include one or more hyperlinks to pages showing particular how-to categories, to web browser 150, which may display the results to the user.

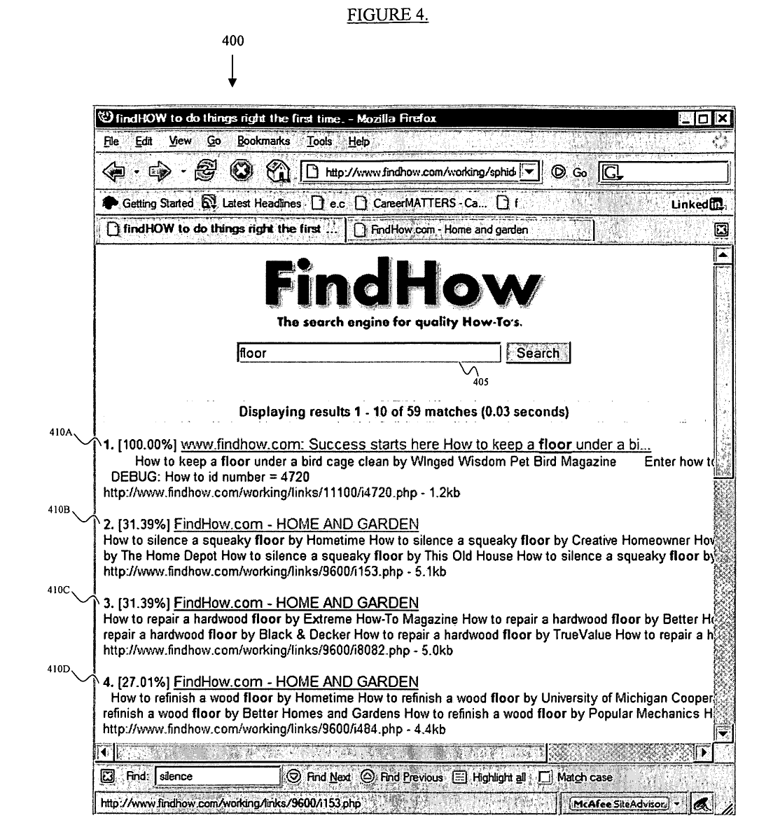

FIG. 4 depicts an example browser interface which a user may employ to supply search terms (e.g., in act 305), and which may be employed to display the results of a search to the user (e.g., in act 315). Browser interface 400 includes box 405, into which a user may supply input defining one or more search terms (in the example shown, “floor”) for use in searching for how-to topics. Also shown on browser interface 400 are results of a search performed using the supplied search terms. Specifically, search results 410A-410D each provide a hyperlink to a how-to topic which includes how-to topics matching the search terms supplied by the user.

At the completion of act 315, process 300 proceeds to act 320, wherein user input is received defining a selection of a how-to topic from those displayed in act 315. For example, the user may click on, or otherwise indicate a selection of, any of the links 410A-410D shown in interface 400.

At the completion of act 320, process 300 proceeds to act 325, wherein one or more how-to entries corresponding to the selected topic are displayed to the user. FIG. 5 depicts an example interface 500 which displays the how-to entries 501A-501H that may be displayed to a user who selects search result 410C in FIG. 4. In this example, each of how-to entries 501A-501H is provided in hyperlink format, wherein each hyperlink references a web page that includes content relating to silencing a squeaky floor. Each of how-to entries 501A-501H includes a brand name, providing an indication to the user of the trustworthiness of the underlying web page. For example, how-to entry 501A includes the brand name “Hometime,” how-to entry 501B includes the brand name “Creative Homeowner,” how-to entry 501C includes the brand name “The Home Depot,” and so on.

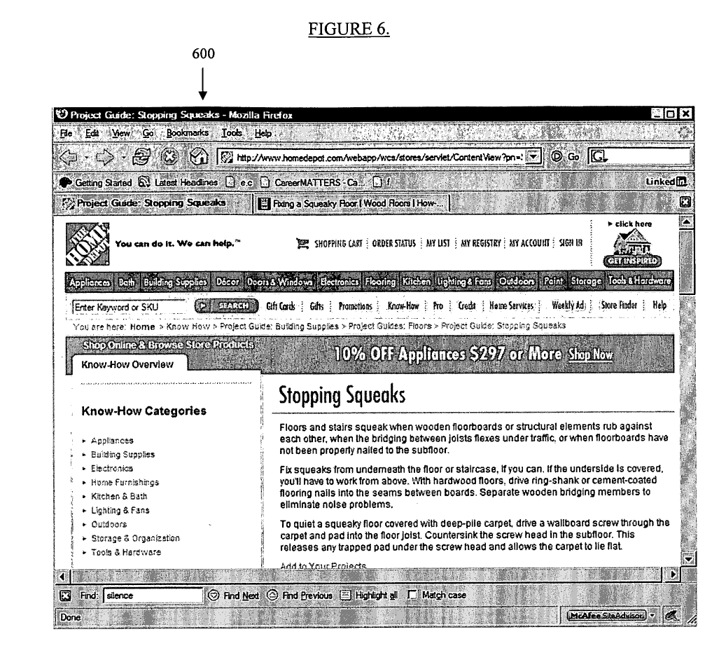

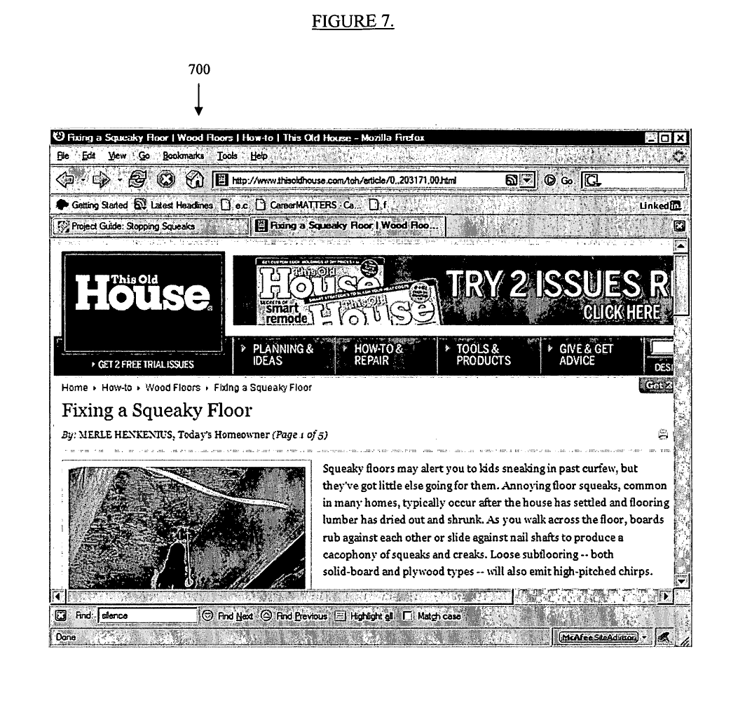

FIGS. 6 and 7 depict exemplary how-to content which may be displayed to the user in response to a selection of one or how-to entries 501A-501H. Specifically, interface 600 displays a web page which may be presented upon the user's selection of how-to name 501C, and interface 700 displays a web page which may be presented upon the user's selection of how-to name 501D.

Upon the completion of act 325, process 300 completes.

It should be appreciated that although process 300 provides a user with access to how-to content by processing the user's search request, a user need not locate how-to content by searching for it. For example, a web site implemented in accordance with embodiments of the invention may allow a user to browse or otherwise navigate various how-to content categories, topics and entries, enabling the user to locate how-to content without necessarily performing a search.

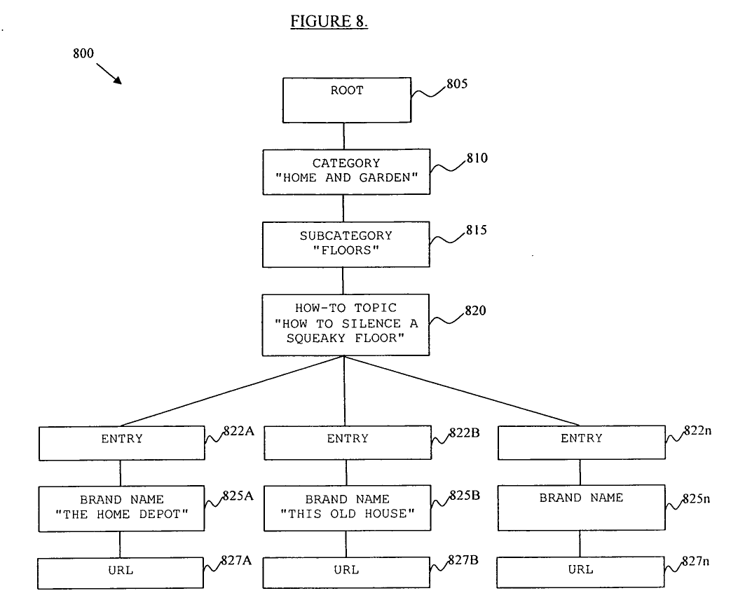

FIG. 8 conceptually depicts one example of a hierarchical scheme for organizing how-to content. FIG. 8 is a partial representation of this scheme, and depicts an example manner of categorizing a particular how-to topic 820 (“How to silence a squeaky floor”). The manner of organizing how-to content represented in FIG. 8 may, for example, be implemented by a web site, such that FIG. 8 may depict a manner of organizing pages on the site according to the content provided on each page. For example, root 805 may, for example, correspond to a home page for a web site from which a user may search for or otherwise locate how-to content.

In the example shown, how-to topic 820 is assigned to sub-category “floors” 815, and to category “home improvement” 810. Although only a single category and sub-category are reflected in FIG. 8, a how-to topic may be assigned to any suitable number of categories and/or sub-categories, as the invention is not limited in this respect. For example, a particular how-to topic may be assigned to multiple top-level categories, and each top-level category may include any suitable number of sub-categories.

How-to entries 822A-822B are assigned to how-to topic 820. Each entry 822 is related to a corresponding brand name 825 and URL 827. Thus, entry 822A is related to brand name 825A (“The Home Depot”) and URL 827A, and entry 822B is related to brand name 825B (“This Old House”) and URL 827B. Each entry corresponds to a web page maintained by an entity corresponding to the brand name and located at the designated URL. Thus, by selecting how-to entry 822A (e.g., using the interface shown in FIG. 5), a user may access how-to content provided by “The Home Depot” at URL 827A, and by selecting entry 822B, a user may access how-to content provided by “This Old House” at URL 827B.

As indicated by entry 822n and corresponding brand name 825n and URL 827n, any suitable number of how-to entries 822 may be assigned to a how-to topic 820, as the invention is not limited in this respect.

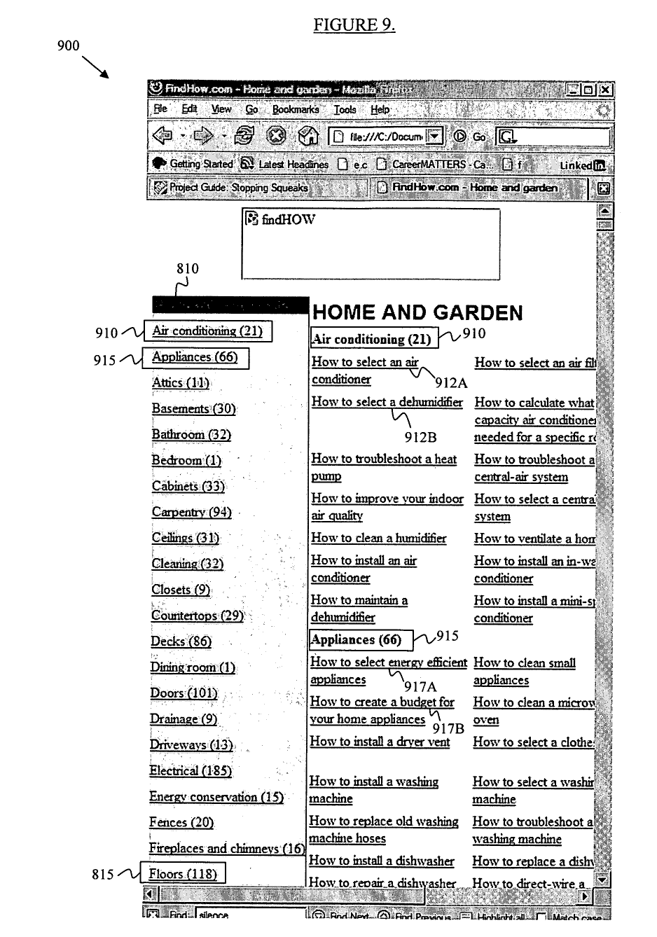

FIG. 9 depicts an example web page 900 which includes information that is organized according to the scheme described above with reference to FIG. 8. For example, web page 900 includes information assigned to category 810 shown in FIG. 8 (i.e., “Home and Garden”). A variety of sub-categories are shown in category 810, including sub-category 815 shown in FIG. 8 (i.e., “Floors”). Sub-categories 910 (“Air Conditioning”) and 915 (“Appliances”), among others, are also shown.

Within sub-categories 910 and 915, a number of how-to topics are shown in FIG. 9. For example, within sub-category 910 (“Air Conditioning”) are how-to topics 912A (“How to Select an Air Conditioner”) and 912B (“How to Select a Dehumidifier”). Similarly, within sub-category 915 (“Appliances”) are how-to topics 917A (“How to Select Energy-Efficient Appliances”) and 917B (“How to Create a Budget for your Home Appliances”). Although not shown in interface 900, each of how-to topics 912A-912B and 917A-917B may have multiple associated how-to entries, each of which may reference a web page provided by a different brand name entity. For example, by selecting (e.g., clicking) how-to topic 912A, a user may cause a collection of how-to entries to be displayed, each including a hyperlink to how-to content provided by a different brand name provider. An example of a collection of how-to entries which may be displayed upon the selection of a particular how-to topic is described above with reference to FIG. 5.

FIG. 10 depicts an example manner of storing how-to-related information (e.g., in database 110, FIG. 1). In particular, FIG. 10 depicts a schema for storing this information in relational format. Of course, it should also be appreciated that any of numerous non-relational data structures may alternatively be employed to store information relating to how-to content, and that a data structure may include different tables than those shown in FIG. 10, or no tables at all if a relational database is not employed.

As those skilled in the art will readily appreciate, schema 1000 includes a plurality of tables, each containing a plurality of fields (e.g., columns) in which data elements relating to how-to information are stored. For example, in the exemplary schema 1000 shown, raw spider results table 1005 stores data elements relating to information retrieved by a spidering module (e.g., website spidering module 105, FIG. 1) in various fields, including a unique identifier, URL, when the URL was found, the editor who found it, and an indication of whether the URL has been accepted for categorization into the system.

As with most relational databases, certain fields in each table are related to fields in other tables via foreign keys to ensure that the information in each table remains consistent. As a result, foreign key 1007 is used to maintain consistency between the URL field in raw spider results table 1005 and the URL field in URL table 1010. URL table 1010 also stores a unique identifier.

Foreign key 1012 maintains consistency between the unique identifier in URL table 1010 and a URL identifier field stored in URL-to-how-to relations table 1015. This table maintains a cross-reference between URLs stored in URLs table 1010 and how-to names stored in how-to names table 1020, described below. Specifically, URL-to-how-to relations table 1015 stores a unique identifier, the URL identifier described above, and a how-to name identifier.

Foreign key 1017 maintains consistency between this how-to name identifier in URL-to-how-to relations table 1015 and the how-to name index field in how-to names table 1020. How-to names table 1020 also stores a sequence number (e.g., which may be used to sort how-to names for display, such as for display on interface 900, FIG. 9), a how-to name, and an indication of the category to which the how-to name belongs.

Foreign key 1022 maintains consistency between this indication of the category to which the how-to name belongs and a category index field stored in categories table 1025. Categories table 1025 also stores an indication of the sequence of each category (e.g., which may be used to sort how-to categories for display, such as on interface 900), a category level number, the category name, and the parent category for each category name.

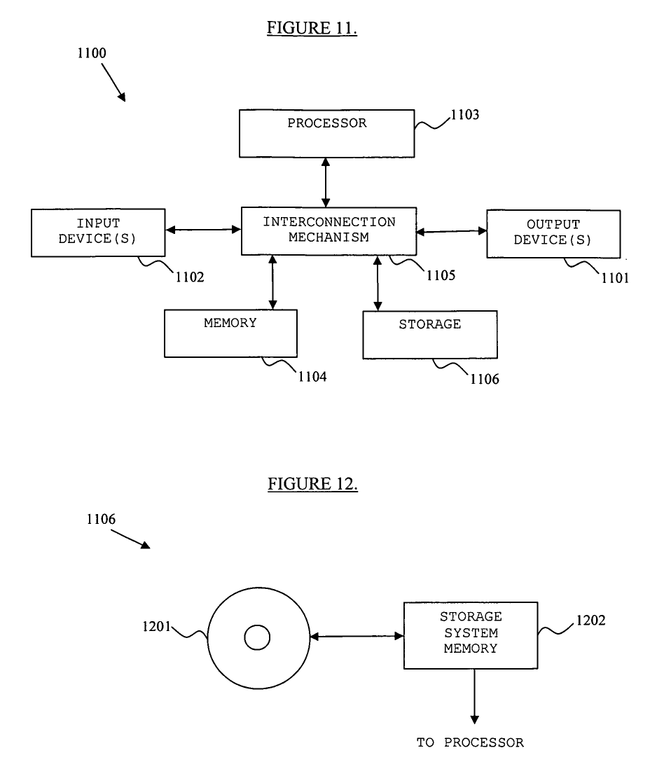

Various aspects of the systems and methods for practicing features of the invention may be implemented on one or more computer systems, such as the exemplary computer system 1100 shown in FIG. 11. Computer system 1100 includes input device(s) 1102, output device(s) 1101, processor 1103, memory system 1104 and storage 1106, all of which are coupled, directly or indirectly, via interconnection mechanism 1105, which may comprise one or more buses, switches, networks and/or any other suitable interconnection. The input device(s) 1102 receive(s) input from a user or machine (e.g., a human operator), and the output device(s) 1101 display(s) or transmit(s) information to a user or machine (e.g., a liquid crystal display). The processor 1103 typically executes a computer program called an operating system (e.g., a Microsoft Windows-family operating system, or any other suitable operating system) which controls the execution of other computer programs, and provides scheduling, input/output and other device control, accounting, compilation, storage assignment, data management, memory management, communication and dataflow control. Collectively, the processor and operating system define the computer platform for which application programs and other computer program languages are written.

The processor 1103 may also execute one or more computer programs to implement various functions. These computer programs may be written in any type of computer program language, including a procedural programming language, object-oriented programming language, macro language, or combination thereof. These computer programs may be stored in storage system 1106. Storage system 1106 may hold information on a volatile or non-volatile medium, and may be fixed or removable. Storage system 1106 is shown in greater detail in FIG. 12.

Storage system 1106 typically includes a computer-readable and writable nonvolatile recording medium 1201, on which signals are stored that define a computer program or information to be used by the program. A medium may, for example, be a disk or flash memory. Typically, in operation, the processor 1103 causes data to be read from the nonvolatile recording medium 1201 into a volatile memory 1202 (e.g., a random access memory, or RAM) that allows for faster access to the information by the processor 1103 than does the medium 1201. The memory 1202 may be located in the storage system 1106, as shown in FIG. 12, or in memory system 1104, as shown in FIG. 11. The processor 1103 generally manipulates the data within the integrated circuit memory 1104, 1202 and then copies the data to the medium 1201 after processing is completed. A variety of mechanisms are known for managing data movement between the medium 1201 and the integrated circuit memory element 1104, 1202, and the invention is not limited thereto. The invention is also not limited to a particular memory system 1104 or storage system 1106.

Having thus described several aspects of at least some embodiments of this invention, it is to be appreciated that various alterations, modifications, and improvements will readily occur to those skilled in the art. Such alterations, modifications and improvements are intended to be part of this disclosure, and are intended to be within the spirit and scope of the invention. Accordingly, the forgoing description and drawings are by way of example only.

For example, one alternative to employing a search facility which allows the user to search for how-to content only on a single web site dedicated to such content is to offer a search facility which enables searching of other web sites (e.g., those representing well-known brands), and uses well-known spidering techniques to index content on those sites. For example, such a search facility might offer users the ability to search sites offered by certain well-recognized or high-quality brand. Further, content filters could be employed to limit the results generated by such a search facility to how-to content, such as by only allowing results which contain phrases such as, for example, “How to,” “Step 1,” “101,” “First, . . . then,” or other phrases.

An alternative approach to having a web site spidering module and/or editors locate URLs would be to have users donate information. For example, users could locate and submit URLs and optionally name how-to entries corresponding thereto. Further, users could provide tags for how-to entries, such as key phrases which might be used to aid in categorization. Further, users could suggest a brand name and/or website of a provider that they would deem trustworthy and reliable to provide information for a particular how-to topic. The provider's website could then be examined by users or editors for potential categorization; if no appropriate content is available, the provider could be encouraged to develop relevant content for the particular how-to topic.

Further, categorization could be performed by users. For example, users could maintain the category hierarchy. As an example, a subset of users could be nominated as approved content editors, and given authority to add how-to entries and edit the categories to which each entry is assigned. Editors could, for example, be limited to adding only how-to entries corresponding to content from previously approved sites.

Of course, another approach would be to employ only certain aspects of the features described above. For example, a system could locate URLs and create corresponding how-to entries, but not categorize them, or name all how-to entries for a certain topic the same. This approach might make it more difficult for users to locate how-to content, but aggregating content without categorizing it might allow content to be assembled more quickly.

The embodiments of the present invention described above can be implemented in any of numerous ways. For example, the functionality described above may be implemented using hardware, software or a combination thereof. When implemented in software, the software code can be executed on any suitable processor or collection of processors, whether provided in a single computer or distributed among multiple computers. In this respect, it should be appreciated that any component or collection of components that perform the functions described herein can be generically considered as one or more controllers that control the above-discussed functions. The one or more controllers can be implemented in numerous ways, such as with dedicated hardware, or by employing one or more processors that are programmed using microcode or software to perform the functions recited above. Where a controller stores or provides data for system operation, such data may be stored in a central repository, in a plurality of repositories, or a combination thereof.

Further, it should be appreciated that a (client or server) computer may be embodied in any of a number of forms, such as a rack-mounted computer, a desktop computer, a laptop computer, or a tablet computer. Additionally, a (client or server) computer may be embedded in a device not generally regarded as a computer but with suitable processing capabilities, including a Personal Digital Assistant (PDA), a smart phone or any other suitable portable or fixed electronic device.

Also, a (client or server) computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface including keyboards, and pointing devices, such as mice, touch pads, and digitizing tables. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. Also, the various methods or processes outlined herein may be coded as software that is executable on one or more processors that employ any one of a variety of operating systems or platforms.

Additionally, such software may be written using any of a number of suitable programming languages and/or conventional programming or scripting tools, and also may be compiled as executable machine language code or intermediate code that is executed on a framework or virtual machine.

In this respect, the invention may be embodied as a storage medium (or multiple storage media) (e.g., a computer memory, one or more floppy disks, compact disks, optical disks, magnetic tapes, flash memories, circuit configurations in Field Programmable Gate Arrays or other semiconductor devices, or other computer storage media) encoded with one or more programs that, when executed on one or more computers or other processors, perform methods that implement the various embodiments of the invention discussed above. The storage medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be provided in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer-implemented method for providing access to trustworthy how-to content, comprising computer-implemented acts of:
(A) locating how-to content made available for access via at least one network by an online provider;
(B) creating in a data structure at least one how-to entry corresponding to the how-to content, the at least one how-to entry being selectable by a user to access the how-to content via at least one network and indicating that the how-to content is made available by the online provider; and
(C) providing the user with access to the at least one how-to entry via at least one network.

2. The method of claim 1, wherein the act (A) further comprises locating content made available for access by the provider via at least one publicly accessible network.

3. The method of claim 1, wherein the act (A) further comprises executing a web spidering facility to identify at least one uniform resource locator (URL) at which the how-to content is located.

4. The method of claim 1, wherein the act (A) further comprises a human editor locating at least one URL at which the how-to content is located.

5. The method of claim 1, wherein the at least one how-to entry indicates that the how-to content is made available by the online provider by including a brand name of the online provider.

6. The method of claim 1, wherein the act (C) further comprises providing a web site which allows the user access to the at least one how-to entry.

7. The method of claim 6, wherein the web site includes information on at least one how-to topic, at least one of the how-to topics including a plurality of how-to entries, each of the plurality of how-to entries relating to performing a substantially same task and having a title which is substantially identical to the title for each other how-to entry of the plurality of how-to entries.

8. At least one computer-readable medium encoded with instructions which, when executed by a computer, perform a method for providing access to trustworthy how-to content, the method comprising acts of:
(A) locating how-to content made available for access via at least one network by an online provider;
(B) creating in a data structure at least one how-to entry which corresponds to the how-to content, the at least one how-to entry being selectable by a user to access the how-to content via at least one network and indicating that the how-to content is made available by the online provider; and
(C) providing the user with access to the at least one how-to entry via at least one network.

9. The at least one computer-readable medium of claim 8, wherein the act (A) further comprises locating content made available for access by the provider via at least one publicly accessible network which includes the Internet.

10. The at least one computer-readable medium of claim 8, wherein the act (B) further comprises creating at least one how-to entry which includes a hyperlink referencing a URL at which the how-to content is located.

11. The at least one computer-readable medium of claim 8, wherein the at least one how-to entry indicates that the how-to content is made available by the online provider by including a brand name of the online provider.

12. The at least one computer-readable medium of claim 8, wherein the act (C) further comprises providing a web site which allows the user access to the at least one how-to entry, and wherein the web site categorizes how-to content using a scheme which includes at least one how-to category, at least one how-to topic and at least one how-to entry, each how-to topic being categorized in at least one how-to category, each how-to entry being categorized in at least one how-to topic.

13. The at least one computer-readable medium of claim 8, wherein the act (C) further comprises providing a search facility which allows the user to search for information relating to how-to content.

14. A system for making trustworthy how-to content available to users, the system comprising:
a location facility operable to receive an indication of a network location at which an item of how-to content is made available for access by an online provider;
a database facility, in networked communication with the location facility, operable to store the indication of the network location received by the location facility;
a creation facility, in networked communication with the database facility, operable to access the indication stored in the database facility and to create, in a data structure, at least one how-to entry for the item of how-to content, the at least one how-to entry being selectable by a user of the system to access the item of how-to content at the network location, the at least one how-to entry indicating that the how-to content is made available by the online provider; and
an access facility operable to make the at least one how-to entry accessible to the user via at least one network.

15. The system of claim 14, further comprising a web site spidering facility, in networked communication with the location facility, operable to identify at least one URL at which how-to content is located and to communicate the at least one URL to the location facility.

16. The system of claim 14, further comprising an editing facility, in networked communication with the location facility, operable to receive input from a human editor specifying at least one URL at which how-to content is located and to communicate the at least one URL to the location facility.

17. The system of claim 14, wherein the creation facility is further operable to create at least one how-to entry, each how-to entry including a hyperlink referencing a URL at which the how-to content is located, and wherein the access facility is further operable to present each hyperlink to the user.

18. The system of claim 14, wherein the access facility comprises a web site providing access to the at least one how-to entry to the user.

19. The system of claim 18, wherein the web site includes information on at least one how-to topic, at least one of the how-to topics including a plurality of how-to entries, each of the plurality of how-to entries relating to performing a substantially same task and having a title which is substantially identical to the title for each other how-to entry of the plurality of how-to entries.

20. The system of claim 14, further comprising a search facility in networked communication with the access facility, wherein the search facility enables the user to search for information relating to how-to content.
